(19) United States
(12) Patent Application Publication
(10) Pub. No.: US 2024/0360919 A1
(43) Pub. Date: Oct. 31, 2024

(54) Apparatus For Facilitating Prevention of Unauthorized Handling of Valves

(71) Applicant: Valentin Fredrick Cardenas, Maricopa, AZ (US)

(72) Inventor: Valentin Fredrick Cardenas, Maricopa, AZ (US)

(21) Appl. No.: 18/649,832

(22) Filed: Apr. 29, 2024

Related U.S. Application Data
(60) Provisional application No. 63/499,052, filed on Apr. 28, 2023.

(51) Int. Cl. F16K 35/10

(52) U.S. Cl. CPC F16K 35/10

(57) ABSTRACT

Aspects described herein relate to a cover for valves. The valve cover has two separate and distinct body's that are hingedly connected about a screw. The valve cover has a first body and a second body. The first and second body both bear a set of parallel walls that are connected by way of a connecting panel from the first end to the second end of each body. Each of the parallel walls have a notch cut into them that allow a transparent body panel to be placed that allows the user to see through the walls of the first body to see the valve contained within.

### FIELD OF THE INVENTION

The present invention relates generally to a field of means to prevent accidental or unauthorized actuation. More specifically, the present invention is an apparatus for facilitating prevention of unauthorized handling of valves.

### BACKGROUND OF THE INVENTION

The field of means to prevent accidental or unauthorized actuation is technologically important to several industries, business organizations and/or individuals. In particular, the use of means to prevent accidental or unauthorized actuation is prevalent for apparatus for facilitating preventing unauthorized handling of valves.

When construction workers work on a live system that may carry something as simple as water to life-ending chemicals. Further, the owners or managers close the valves of the system and put clamshells over the valves, and attach a lock to the clamshells so that nobody can re-energize the system except the owners or the managers once the work is done. The workers may not witness the closing of the valves. Sometimes, the managers or owners forget to close the valves and put the clamshells without closing the valves. Further, many people may die and get seriously injured because the person putting on the clamshell forgot to close the valve he just put the clamshell on and completely spaced out de-energizing the system. Further, when the workers come back to work on the system which is supposed to be de-energized and if the valve was not closed off whatever the system is carrying comes gushing out and may not stop until the person that put on the clamshell comes and takes off the lock opens up the clamshell and closes off the valve.

Therefore, there is a need for an improved apparatus for facilitating prevention of unauthorized handling of valves that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, an apparatus for facilitating prevention of unauthorized handling of a valve is disclosed. Accordingly, the apparatus may include a first part and a second part. Further, the first part may include a first hollow flattened body of a half-cylindrical shape. Further, the first part may include a first end and a second end diametrically opposite to the first end. Further, a first opening may be defined between the first end and the second end of the first part. Further, the first opening may lead into the first hollow flattened body. Further, the first hollow flattened body may include a first pair of panels. Further, each panel of the first pair of panels may be opposing each other. Further, a semi-circular notch may be defined in each panel of the first pair of panels. Further, the first hollow flattened body may include a first side wall peripherally disposed around the first pair of panels defining a first channel. Further, the second part may include a second hollow flattened body of a half-cylindrical shape. Further, the second part may include a first end and a second end diametrically opposite to the first end. Further, a second opening may be defined between the first end and the second end of the second. Further, a second opening may be defined between the first end and the second end of the second part. Further, the second opening may lead into the second hollow flattened body. Further, the second hollow flattened body may include a second pair of panels. Further, each panel of the second pair of panels may be opposing each other. Further, a semi-circular notch may be defined in each panel of the second pair of panels. Further, the second hollow flattened body may include a second side wall peripherally disposed around the second pair of panels defining a second channel. Further, the first part and the second part may be symmetrical. Further, the first part and the second part may form an openable enclosure with a pair of circular panels. Further, the apparatus may include a transparent flattened body removably insertable in the openable enclosure. Further, the openable enclosure may enclose the valve to prevent unauthorized handling of the valve.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a perspective view of the present invention.

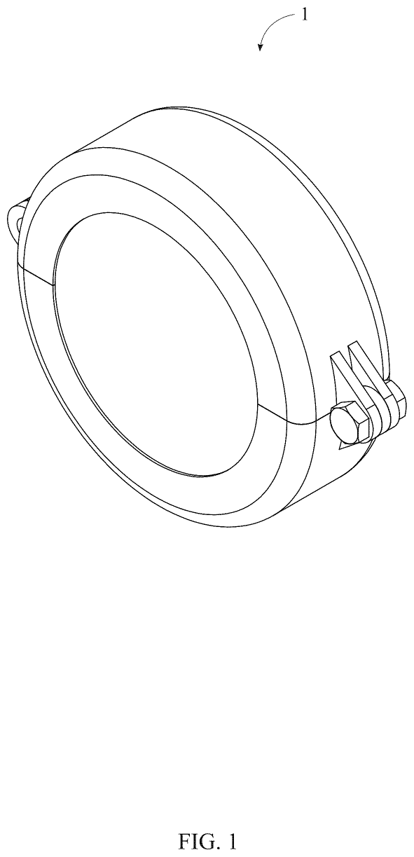

FIG. 2 is top view of the present invention.

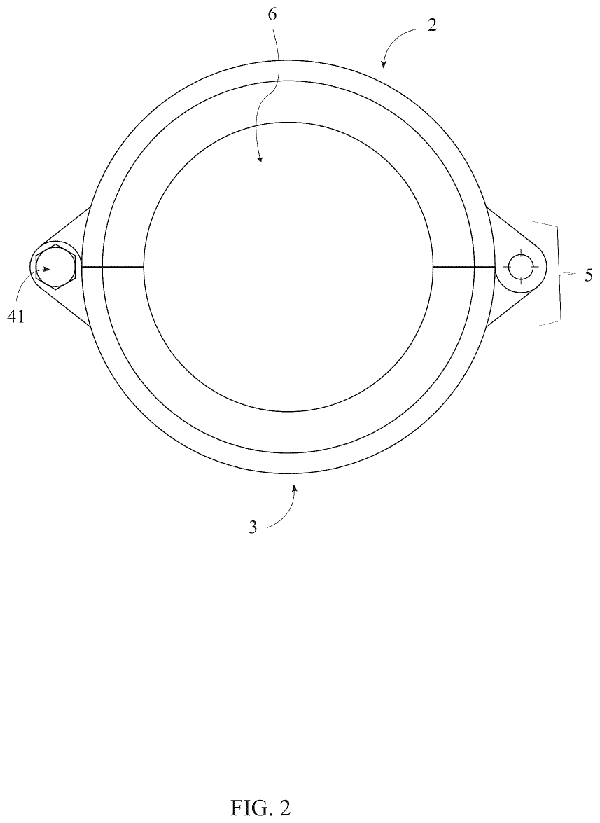

FIG. 3 is a bottom view of the present invention.

FIG. 4 is a left view of the present invention.

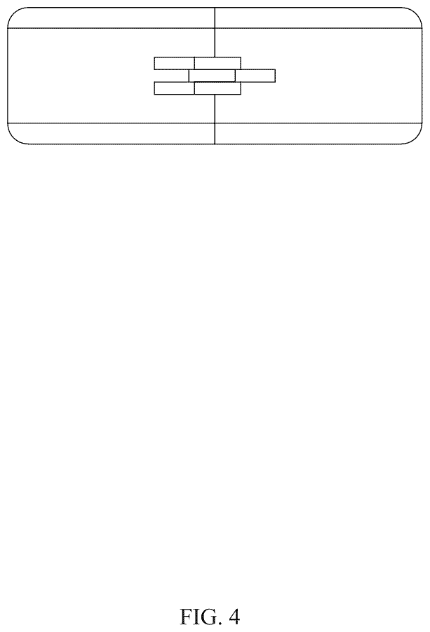

FIG. 5 is right view of the present invention.

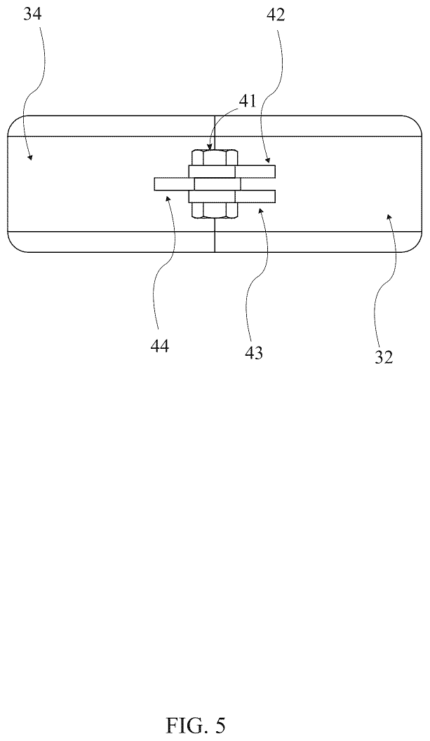

FIG. 6 is a rear view of the present invention.

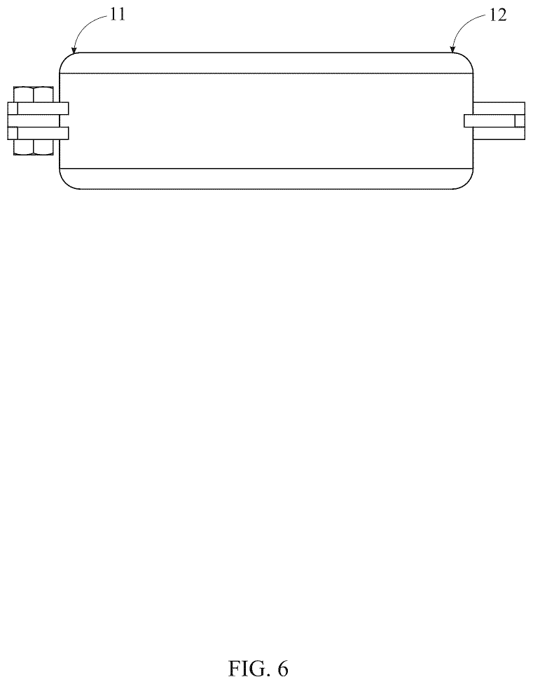

FIG. 7 is a front view of the present invention.

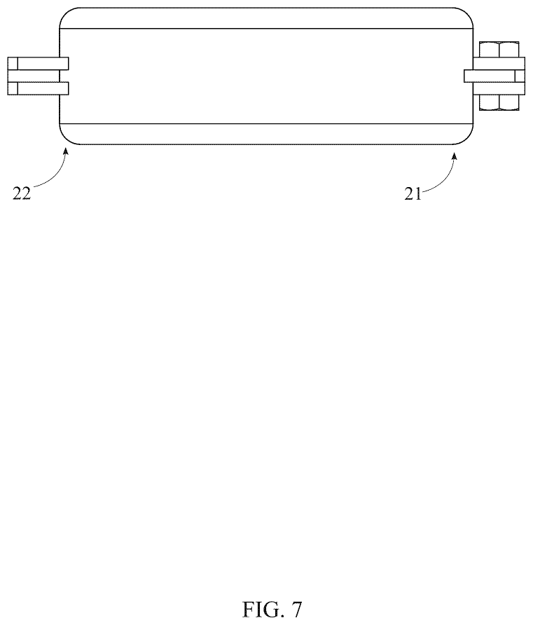

FIG. 8 is the present invention in an open position showing the internal surfaces of the present invention.

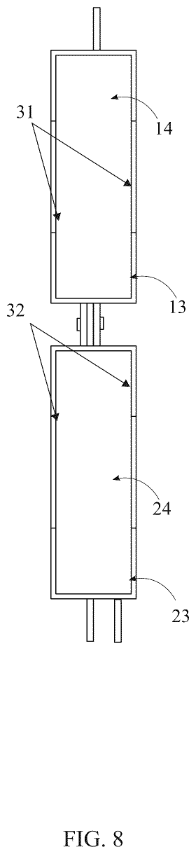

FIG. 9 is a bottom-left-top view of the present invention.

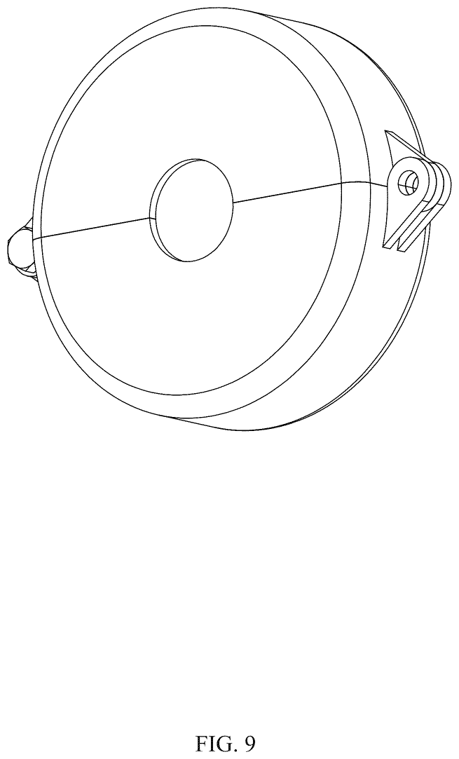

FIG. 10 is a front view of the first body.

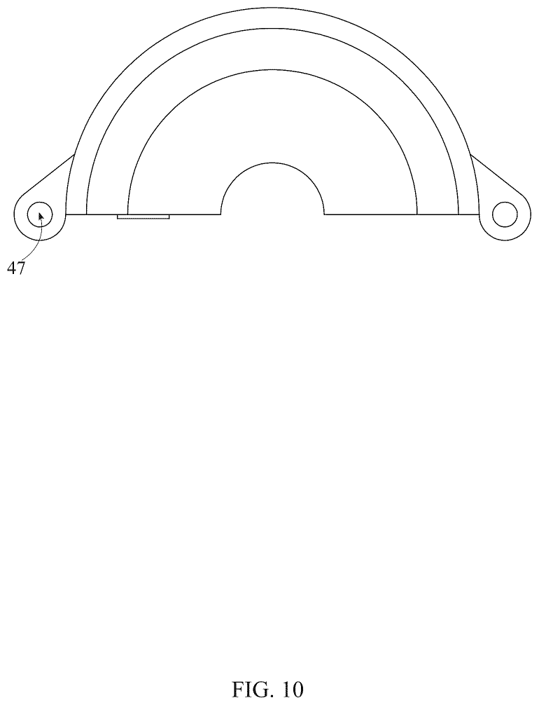

FIG. 11 is rear-left view of the second body.

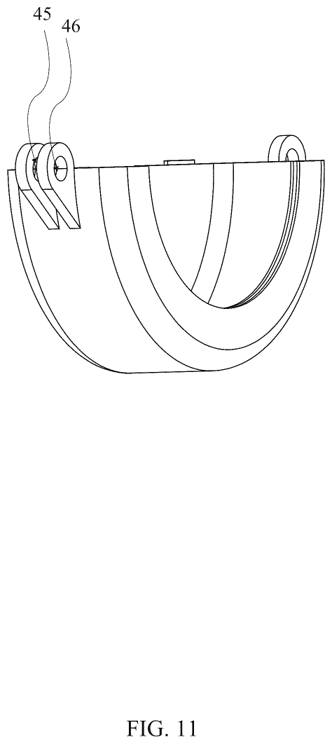

FIG. 12 is front view of the present invention

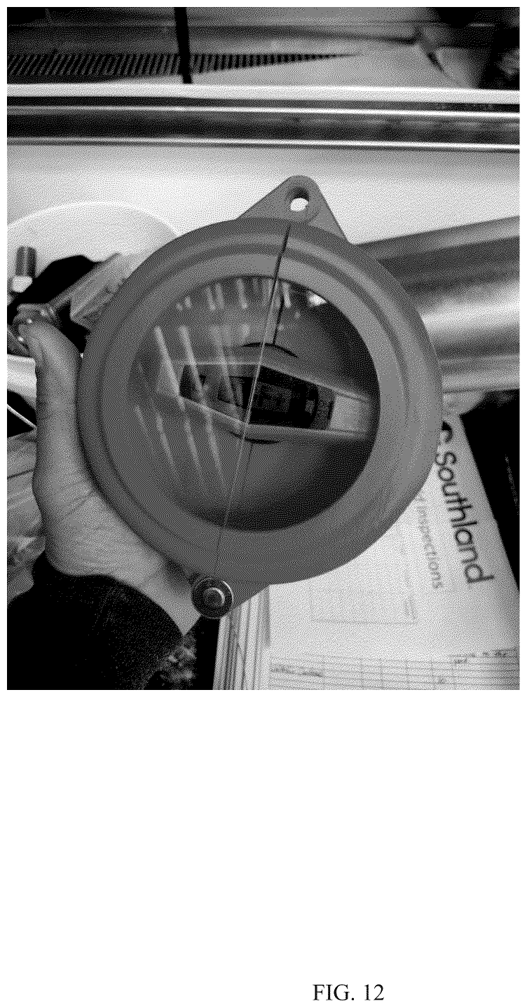

FIG. 13 is a front and rear view of the present invention

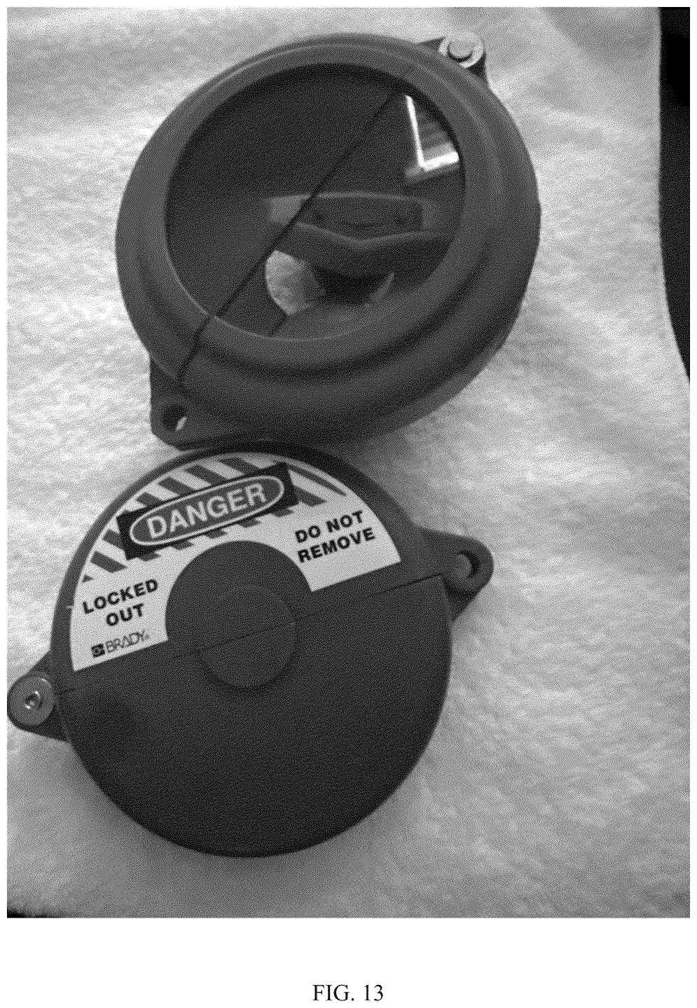

FIG. 14 various views of the present invention.

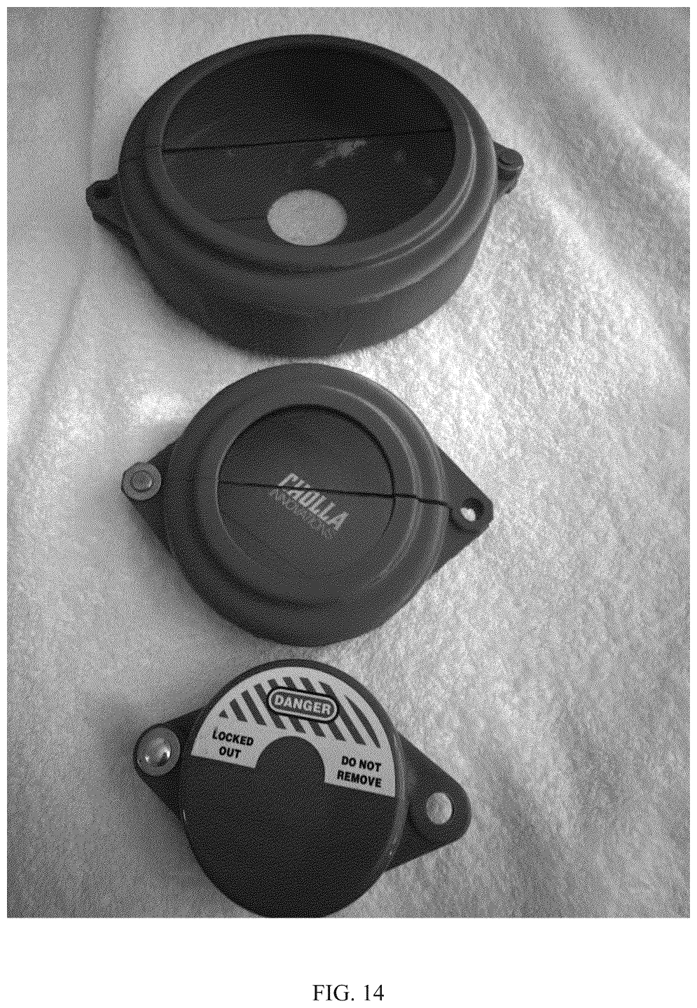

FIG. 15 is a rear view of the present invention.

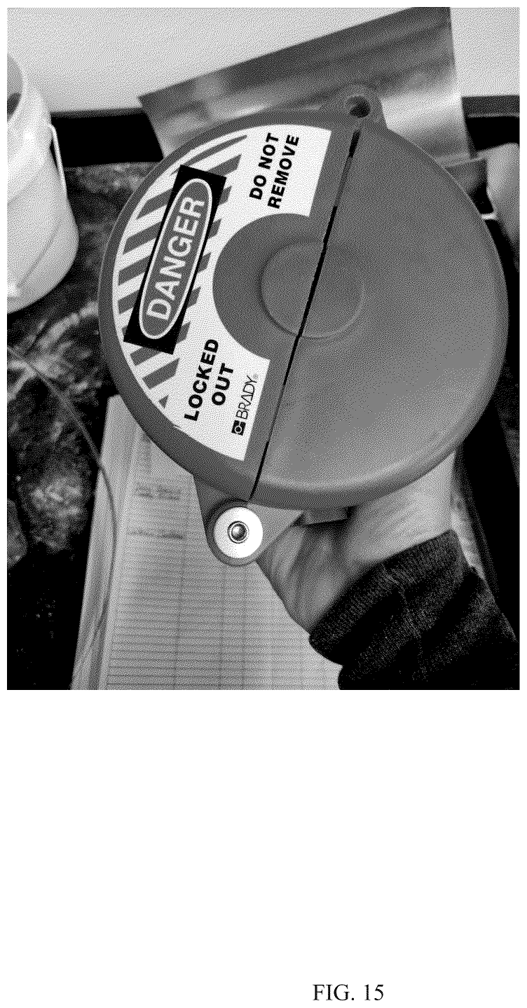

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of an apparatus for facilitating prevention of unauthorized handling of valves, embodiments of the present disclosure are not limited to use only in this context.

The present disclosure describes an apparatus for facilitating prevention of unauthorized handling of valves. Further, the disclosed apparatus may include a see-through face that may be some sort of plastic material shaped like a hockey puck that may slide into a channel that needs to be built into the body. The apparatus may help save the lives of construction workers all over the world by eliminating not being able to see if the valve is in the closed or open position since it may include a see-through face that workers may be able to look through to verify themselves the valve is in the closed position before cutting into the system. The apparatus may be wide enough to accommodate the hockey puck and deep enough so the hockey puck sits securely inside while still allowing for the most see-through face as possible. The hockey puck may include a larger diameter of at least ¾ of a clamp face with a track to accommodate the hockey puck. Further, the track may be ⅛″ wide all around and may be able to accommodate the puck being inserted into it and hold the hockey puck in place.

As depicted in the figures is an apparatus for facilitating prevention of unauthorized handling of a valve, in accordance with some embodiments. Accordingly, the apparatus comprises a first body 2, a second body 3, a latching mechanism 5, and a hinge 4. The first body 2 may include a first hollow flattened body of a half-cylindrical shape. Further, the first body 2 has a first end 11 and a second end 12 diametrically opposite to the first end 11 of the first body 2. A first opening 13 is be defined between the first end 11 and the second end 12 of the first body 2. The first opening 13 leads into the first hollow flattened body. The first body 2 is defined by a first pair of panels 31. The first body 2 has a first connecting wall 32 peripherally disposed around the first pair of panels 31. The first connecting wall 32 along with the first pair of panels 31 defines a first channel 14. The first body 2 has an external surface 35.

The second body 3 includes a second hollow flattened body of a half-cylindrical shape. The second body 3 has a first end 21 and a second end 22 diametrically opposite to the first end 21. A second opening 23 is defined between the first end 21 and the second end 22 of the second body 3. The second opening leads 23 into the second hollow flattened body. The second body 3 comprises a second pair of panels 33 and the second body 3 has an external surface 36. Each panel of the second pair of panels 33 opposes each other with each of the panels in the second pair of panels 33 being parallel to one another. The second body 3 comprises a second connecting wall 34 peripherally disposed around the second pair of panels 33. The second connecting wall 32, along with each of the panels in the second pair of walls defines a second channel 24.

The first body 2 and the second body 3 are symmetrical. The first body 2 and the second body 3 are hingedly coupled at the first end 11 of the first body 2 and the first end 21 of the second body 3. The first body 2 and the second body 3 are also latched using a latching mechanism 5 at the second end 12 of the first body 2 and the second end 22 of the second body 3. The hinge 4 comprises a first connecting panel 42, a second connecting panel 43 and a third connecting panel 44. The hinge 4 further comprises a screw 41. The first connecting panel 42, second connecting panel 43 and third connecting panel 44 and connected by way of a screw 41.

The screw 41 traverses through the first connecting aperture 45, the second connecting aperture 46, and the third connecting aperture 47. When the screw 41 is inserted through all three apertures, it allows the first body 2 and second to be rotated about the screw 41 forming a hinge 4. The first connecting panel 42 has a first connecting aperture 45 centrally positioned on the panel. The second connecting panel 43 has a second connecting aperture 45 centrally positioned on the panel. The third connecting panel 44 has a third connecting aperture 47 centrally positioned on the panel. The first connecting panel 42 and the second connecting panel 43 are parallel to one another.

The first connecting panel 42 and the second connecting panel 43 are positioned on the external surface 35 of the first body 2 while the third connecting panel 44 is positioned on the external surface 36 of the second body 3 at the first end of the second body 3. When the first body 2 and the second body 3 come together to connect, the third connected panel ends up positioned between the first connecting panel 42 and the second connecting panel 43.

The first pair of panels 31 is defined with a notch 61 and the second pair of panels 33 is also defined with a notch 62. When the first body 2 and the second body 3 are connected, which would have the valve cover 1 in a closed position, a transparent flattened body 6 is fitted in the notches, allowing the user to see through to the valve when the valve cover 1 is in position and the unit is in a closed position.

Further, the latching mechanism 5 comprises a first latching panel 51 disposed at the second end 22 of the first body 2 and a second latching panel 52 disposed at the second end 22 of the second body 3. The first latching panel 51 is positioned on the external surface 35 of the first body 2 and the second latching panel 52 is positioned on the external surface 36 of the second body 3. Further, the first latching panel 51 and the second latching panel 52 may be configured to transition between an engaged state and an unengaged state. Further, the engaged state may be achieved by bringing the second end 12 of the first body 2 and the second end 22 of the second body 3 closer. Further, in the engaged state, the first body 2 and the second body 3 may form an openable enclosure with a pair of circular panels. Further, the semi-circular notches defined in each panel of the first pair of panels 31 and the semi-circular notch defined in each panel of the second pair of panels may form a circular hole in each panel of the pair of circular panels of the openable enclosure. A notch is needed in both panels of the first pair of panels 31 and both panels of the second pair of panels as one notch allows for the valve tubing to come up into the valve cover 1 and the second notch holds the transparent flattened body 6.

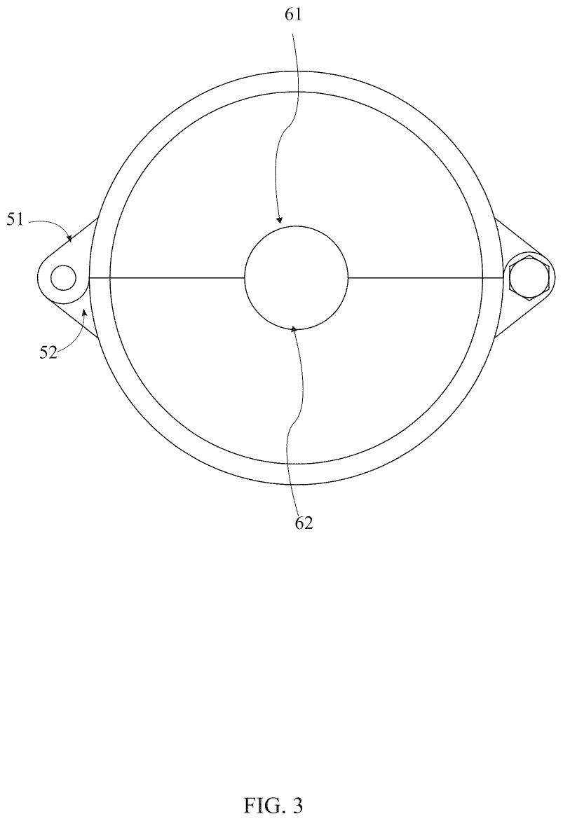

Further, the apparatus may include a transparent flattened body 6, as shown in FIG. 3, removably insertable in the openable enclosure. Further, the transparent flattened body 6 may be accommodated inside the first channel 14 and the second channel 24 based on the inserting. Further, the openable enclosure may enclose the valve to prevent unauthorized handling of the valve. Further, the transparent flattened body 6 may allow an individual to see a state of the valve. Further, the state of the valve may include an opened state and a closed state.

Further, in some embodiments, the apparatus may include a clamshell. Further, the transparent flattened body 6 may be circular in shape depicting a hockey puck.

Although the invention has been explained in relation to its preferred embodiment, it is to be understood that many other possible modifications and variations can be made without debodying from the spirit and scope of the invention.

Further, the apparatus may include a transparent flattened body, as shown in FIG. 3, removably insertable in the openable enclosure. Further, the transparent flattened body may be accommodated inside the first channel and the second channel based on the inserting. Further, the openable enclosure may enclose the valve to prevent unauthorized handling of the valve. Further, the transparent flattened body may allow an individual to see a state of the valve. Further, the state of the valve may include an opened state and a closed state.

Further, in some embodiments, the apparatus may include a clamshell. Further, the transparent flattened body may be circular in shape depicting a hockey puck.

Although the invention has been explained in relation to its preferred embodiment, it is to be understood that many other possible modifications and variations can be made without departing from the spirit and scope of the invention.

What is claimed is:

1. A valve cover comprising:
a first body;
a second body;
a hinge;
a latching mechanism;
the first body having a first end and a second end
the second body having a first end and a second end
the first body comprising a first pair of panels;
the second body comprising a second pair of panels;
the first body having an external surface; and
the second body having an external surface.

2. The valve cover as claimed in claim 1 comprising:
the first end of the first body being diametrically opposite to the second end of the first body; and
a first opening being defined between the first end and second end of the first body.

3. The valve cover as claimed in claim 1 comprising:
the first end of the second body being diametrically opposite to the second end of the second body; and
a second opening being defined between the first end and second end of the second body.

4. The valve cover as claimed in claim 1 comprising:
the first pair of panels being parallel to one another;
the second pair of panels being parallel to one another;
a first channel being defined between the first pair of panels;
a second channel being defined between the first pair of panels;
a first connecting wall is peripherally disposed around the first pair of panels; and
a second connecting wall is peripherally disposed around the second pair of panels.

5. The valve cover as claimed in claim 1
the hinge comprising a first connecting panel, a second connecting panel, a third connecting panel and a screw.
the first body and second body being hingedly connected;
the first connecting panel have a first connecting aperture centrally positioned on the panel;
the second connecting panel have a second connecting aperture centrally positioned on the panel;
the third connecting panel having a third connecting aperture centrally positioned on the panel; and
the screw traversing through the first connecting aperture, the second connecting aperture, and the third connecting aperture.

6. The valve cover as claimed in claim 5 comprising:
the first connecting panel and the second connecting panel being parallel to one another.

7. The valve cover as claimed in claim 5
the first connecting panel and the second connecting panel being positioned on the external surface of the first body; and
the third connecting panel being positioned on the external surface of the second connecting wall at the first end of the second body.

8. The valve cover as claimed in claim 1 comprising:
a notch being defined in each panel of the first pair of panels.

9. The valve cover as claimed in claim 1 comprising:
a notch being defined in each panel of the second pair of panels; and
a transparent flattened body being fitted in the notches of the first body.

10. The valve cover as claimed in claim 1 comprising:
the latching mechanism comprising a first latching panel and a second latching panel;
the first latching panel being positioned on the external surface of the first connecting wall at the second end of the first body;
a second latching panel being positioned on the external surface of the second connecting wall of the at the second end of the second body;
a first latching aperture centrally positioned on the first latching panel; and
a second latching aperture centrally positioned on the second latching panel.

11. A valve cover comprising:
a first body;
a second body;
a hinge;
a latching mechanism;
the first body having a first end and a second end
the second body having a first end and a second end
the first body comprising a first pair of panels;
the second body comprising a second pair of panels;
the first body having an external surface; and
the second body having an external surface.

12. The valve cover as claimed in claim 11 comprising:
the first end of the first body being diametrically opposite to the second end of the first body; and
a first opening being defined between the first end and second end of the first body;
the first end of the second body being diametrically opposite to the second end of the second body; and
a second opening being defined between the first end and second end of the second body.

13. The valve cover as claimed in claim 11 comprising:
the first pair of panels being parallel to one another;
the second pair of panels being parallel to one another;
a first channel being defined between the first pair of panels;
a second channel being defined between the first pair of panels;
a first connecting wall is peripherally disposed around the first pair of panels
a second connecting wall is peripherally disposed around the second pair of panels.

14. The valve cover as claimed in claim 11
the hinge comprising a first connecting panel, a second connecting panel, a third connecting panel and a screw.
the first body and second body being hingedly connected;
the first connecting panel have a first connecting aperture centrally positioned on the panel;
the second connecting panel have a second connecting aperture centrally positioned on the panel;
the third connecting panel having a third connecting aperture centrally positioned on the panel;
the screw traversing through the first connecting aperture, the second connecting aperture, and the third connecting aperture; and
the first connecting panel and the second connecting panel being parallel to one another.

15. The valve cover as claimed in claim 14 comprising:
the first connecting panel and the second connecting panel being positioned on the external surface of the first body; and
the third connecting panel being positioned on the external surface of the second connecting wall at the first end of the second body.

16. The valve cover as claimed in claim 11 comprising:
a notch being defined in each panel of the first pair of panels.
a notch being defined in each panel of the second pair of panels.
a transparent flattened body being fitted in the notches of the first body.
the latching mechanism comprising a first latching panel and a second latching panel;

17. The valve cover as claimed in claim 16 comprising:
the first latching panel being positioned on the external surface of the first connecting wall at the second end of the first body;
a second latching panel being positioned on the external surface of the second connecting wall of the at the second end of the second body;
a first latching aperture centrally positioned on the first latching panel; and
a second latching aperture centrally positioned on the second latching panel.
